(19) United States
(12) Patent Application Publication
(10) Pub. No.: US 2026/0229096 A1
(43) Pub. Date: Aug. 6, 2026

(54) SYSTEMS AND METHODS FOR ITEM IDENTIFICATION

(71) Applicant: Walmart Apollo, LLC, Bentonville, AR (US)

(72) Inventors: Padmini Madarapakam Pagadala, Bentonville, AR (US); Kevin J. Kowalski, Bella Vista, AR (US)

(21) Appl. No.: 19/465,796

(22) Filed: Jan. 30, 2026

Related U.S. Application Data
(60) Provisional application No. 63/752,160, filed on Jan. 31, 2025.

(51) Int. Cl. G07G 1/00; G06N 20/00

(52) U.S. Cl. CPC G07G 1/0045; G06N 20/00

(57) ABSTRACT

Systems, apparatuses, and methods are provided herein useful to identify items at checkout stations. In some embodiments, a checkout station includes an item staging area, an optical scanner, a display, and a computer vision system. The computer vision system may include a camera, a control circuit, and a machine-readable medium that stores instructions. The control circuit may execute a trained machine learning model to: determine whether a machine-readable code is received, identify the item based on the captured image, automatically update content shown in the display to identify the item, automatically update the content to provide at least two items similar to the item with a prompt for a user selection of the item, and automatically update the model. The control circuit may execute the model to automatically update the content to provide a prompt to scan the item.

### CROSS-REFERENCE TO RELATED APPLICATIONS

This application claims the benefit of U.S. Provisional Application No. 63/752,160, filed January 31, 2025, which is incorporated herein by reference in its entirety.

### BACKGROUND

Purchasing items at a self-checkout station or a cashier-assisted checkout station of a retail store can either be a quick or a slow process depending on how fast the checkout system identifies the scanned items or how fast the purchaser is able to perform a lookup of the item in the item database. Sometimes, conventional checkout systems do not identify or recognize the scanned barcode of an item. In such a case, a purchaser at a self-checkout station would be required to call for assistance and wait for an available associate to come and help. At a cashier-assisted checkout station, the cashier would have to type the full barcode number into the checkout system. Both scenarios delay the completion of the purchase transaction.

### BRIEF DESCRIPTION OF DRAWINGS

Various examples will be described below with reference to the following figures:

FIG. 1 illustrates an example item identification system in accordance with some embodiments;

FIG. 2 illustrates an example staging area of an item identification system in FIG. 1 in accordance with some embodiments;

FIG. 3 is an illustration of an exact identification rule in accordance with some embodiments;

FIG. 4 is an illustration of a picklist rule in accordance with some embodiments;

FIG. 5 is an illustration of a customer nudge option in accordance with some embodiments;

FIG. 6 is an illustration of a shrink detect option in accordance with some embodiments;

FIGS. 7A through 7E are flow diagrams depicting example methods for item identification in accordance with some embodiments; and

FIG. 8 is a block diagram depicting a machine-readable medium encoded with example instructions to identify an item in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Although certain actions and/or steps may be described or depicted in a particular order of occurrence, those actions and/or steps are not limited to that order and may be performed in a different order or occurrence. The terms and expressions used herein have the ordinary technical meaning as is accorded to such terms and expressions except where different specific meanings have otherwise been set forth herein.

### DETAILED DESCRIPTION

Generally speaking, pursuant to various embodiments, systems, apparatuses and methods are provided herein useful to identify items for transaction completion. An item identification system for transaction completion includes an item staging area to receive one or more items to be included in a transaction at a facility; an optical scanner to capture a machine-readable code of an item of the one or more items to identify the item; a display; and a computer vision system. The computer vision system includes a camera having a lens to capture an image of the item when a presence of the item is detected; a control circuit; and a machine-readable medium storing instructions. The machine-readable medium storing instructions, when executed by the control circuit, may cause the control circuit to execute a trained machine learning model to determine whether the machine-readable code of the item is received by the control circuit; and identify the item based on the image captured by the camera. In some embodiments, upon a determination that the machine-readable code of the item is received and upon a determination that the machine-readable code and the image do not correspond to a same item, automatically update content shown in the display to identify the item based on the image.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

In some embodiments, upon a determination that the machine-readable code is not received and the trained machine learning model is able to determine an item sub-category corresponding to the item based on the image but unable to identify the item, automatically update, by the trained machine learning model, content shown in the display to provide at least two items similar to the item with a prompt for a user selection of the item intended for purchase. In some embodiments, the trained machine learning model is automatically updated.

In some embodiments, upon a determination that the machine-readable code is not received and the trained machine learning model is able to determine an item category corresponding to the item based on the image but unable to identify the item, the trained machine learning model automatically updates the content shown in the display to provide a prompt to scan the item with the optical scanner.

In some embodiments, upon a determination that the machine-readable code is not received and the trained machine learning model is unable to identify the item but the item has been indicated by the user/purchaser that the item has been presented for purchase, the trained machine learning model automatically updates the content shown in the display to provide a prompt to scan the item with the optical scanner.

In some embodiments, a method for transaction completion includes receiving, at an item staging area, one or more items to be included in a transaction at a facility. Alternatively or in addition, the method may include capturing, by an optical scanner, a machine-readable code of an item of the one or more items to identify the item. Alternatively or in addition, the method may include capturing, by a camera of a computer vision system having a lens, an image of the item when a presence of the item is detected. Alternatively or in addition, the method may include determining, by a trained machine learning model when executed by a control circuit of the computer vision system, whether the machine-readable code of the item is received by the control circuit. Alternatively or in addition, the method may include identifying, by the trained machine learning model when executed by the control circuit, the item based on the image captured by the camera. Alternatively or in addition, the method may include, where upon a determination that the machine-readable code of the item is received and upon a determination that the machine-readable code and the image do not correspond to a same item, automatically updating, by the trained machine learning model when executed by the control circuit, content shown in the display to identify the item based on the image. Alternatively or in addition, the method may include, where upon a determination that the machine-readable code is not received and the trained machine learning model is able to determine an item sub-category corresponding to the item based on the image but unable to identify the item, automatically updating, by the trained machine learning model when executed by the control circuit, content shown in a display to provide at least two items similar to the item with a prompt for a user selection of the item intended for purchase. In some embodiments, the method includes automatically updating, by the trained machine learning model when executed by the control circuit, the trained machine learning model. Alternatively or in addition, the method may include, where upon a determination that the machine-readable code is not received and the trained machine learning model is able to determine an item category corresponding to the item based on the image but unable to identify the item, automatically updating, by the trained machine learning model when executed by the control circuit, the content shown in the display to provide a prompt to scan the item with the optical scanner. Alternatively or in addition, the method may include, where upon a determination that the machine-readable code is not received and the trained machine learning model is unable to identify the item but the item has been indicated by the user/purchaser that the item has been presented for purchase, automatically updating, by the trained machine learning model when executed by the control circuit, the content shown in the display to provide a prompt to scan the item with the optical scanner.

In some embodiments, a non-transitory machine-readable medium storing instructions executable by a control circuit of a computer vision system executing a trained machine learning model, the non-transitory machine-readable medium includes instructions to determine whether a machine-readable code of an item captured by an optical scanner is received by the control circuit, wherein the item is received at an item staging area. Alternatively or in addition, the non-transitory machine-readable medium may include instructions to identify the item based on an image captured by a camera of the computer vision system. Alternatively or in addition, the non-transitory machine-readable medium may include instructions to automatically update content shown in the display to identify the item based on the image upon determining that the machine-readable code of the item is received and upon determining that the machine-readable code and the image do not correspond to a same item. Alternatively or in addition, the non-transitory machine-readable medium may include instructions to automatically update content shown in a display to provide at least two items similar to the item with a prompt for a user selection of the item intended for purchase upon determining that the machine-readable code is not received and the trained machine learning model is able to determine an item sub-category corresponding to the item based on the image but unable to identify the item. Alternatively or in addition, the non-transitory machine-readable medium may include instructions to automatically update the trained machine learning model in response to the user selection. Alternatively or in addition, the non-transitory machine-readable medium may include instructions to automatically update the content shown in a display to provide a prompt to scan the item with the optical scanner upon determining that the machine-readable code is not received and the trained machine learning model is able to determine an item category corresponding to the item based on the image but unable to identify the item. Alternatively or in addition, the non-transitory machine-readable medium may include instructions to automatically update the content shown in the display to provide a prompt to scan the item with the optical scanner upon determining that the machine-readable code is not received, and the trained machine learning model is unable to identify the item but the item has been indicated by the user/purchaser that the item has been presented for purchase.

Moreover, various embodiments, systems, apparatuses and methods are provided herein useful to identify items to facilitate the completion of the purchase transaction at self-checkout, a cashier-assisted checkout, and/or fully automated/autonomous, and/or semi-automated/autonomous checkout system and/or station. For example, a purchase transaction may be completed anywhere in the facility in an area designated and/or recognized by the trained machine learning model to be an area where the purchase transaction can be completed. Further, in some embodiments, item identification systems may be used separately from a purchase transaction or checkout station. That is, while some embodiments described herein are in the context of identifying items during a purchase transaction, it is understood that item identification in accordance with some embodiments is in another context. For example, in some embodiments, items may be identified at locations to determine items in possession of a user or items passing a checkpoint or location, items received at a facility such as shipment, being dispensed from a facility, items being returned in a return transaction, items being released to a user in a pickup transaction, items identified at facility exit (such as store exit validation which may traditionally be performed by an exit associate), and so on.

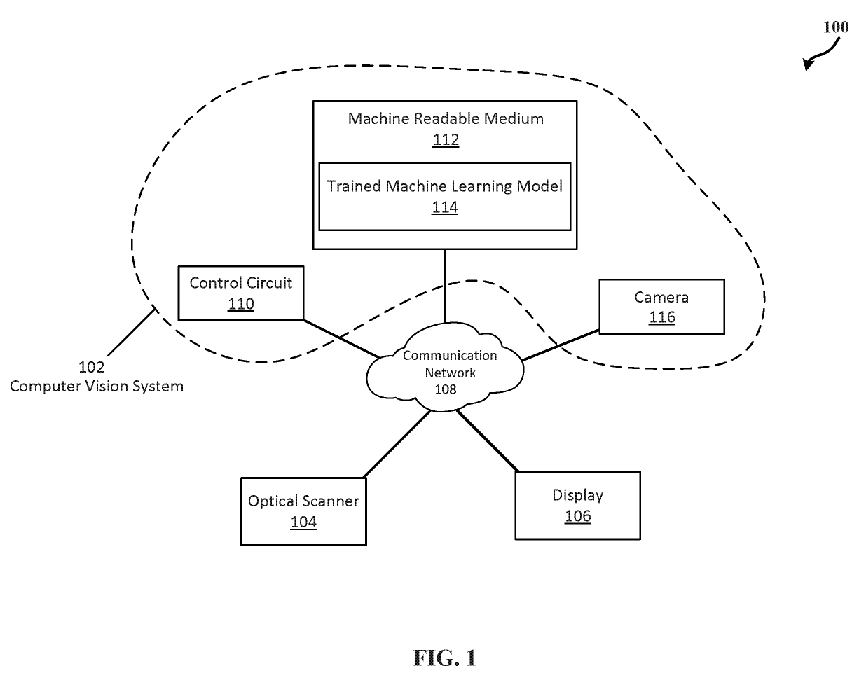

FIG. 1 illustrates an example item identification system 100 in accordance with some embodiments. In some embodiments, the item identification system 100 includes a computer vision system 102, optical scanner(s) 104, and display(s) 106 operably coupled via a communication network 108. The communication network 108 may include a wired and/or a wireless network, Internet, a local area network, a private network, any public and/or private network that allows electronic devices to communicate to one another, or any combination thereof. The optical scanner 104 may include any electronic device capable of capturing machine-readable code (e.g., barcode reader, quick response (QR) code reader, embedded watermarks, to name a few). In some embodiments the optical scanner 104 may be more generically considered a scanner or scanning device capable of sensing or receiving identification information of an item, such as including being implemented as a radio-frequency identification (RFID), near field communication (NFC), inductive coupling, electromagnetic reader, and so on. In some embodiments, the optical scanner 104 operatively works in cooperation with the computer vision system 102 to enable the item identification system 100 to perform the functions described herein. The display 106 may include any electronic device for the visual presentation of data. In some embodiments, the display 106 may include at least one of a display of a smartphone, standalone display, a smartwatch, a display associated with a checkout station, a display associated with a non-checkout station (such as a return station, pickup station, shipment reception stations, etc.) or any combination thereof. In some embodiments, the optical scanner 104 and the display 106 may be integrated into an electronic device (e.g., a smartphone, a tablet, a laptop, a standalone computer, a station, to name a few).

In some embodiments, the computer vision system 102 includes a control circuit 110, a machine-readable medium 112, and/or camera(s) 116. While one camera 116 is shown in FIG. 1, it will be appreciated that the computer vision system 102 may include more than one camera 116. The camera(s) 116 may have lens to capture image(s) of the item(s) when a presence of the item(s) is/are detected proximate the item staging area 202. The control circuit 110 may include one or more processors or any hardware component in a circuit board of a smart device or a computer that receives information from an input, fulfills a command, and delivers the result to a designated output. The machine-readable medium 112 may include read only memory (ROM), random access memory (RAM), hard disk drives, solid state drive, to name a few, or any one or more electronic devices capable of storing electronic data and accessible locally and/or remotely (cloud-based storage). In some embodiments, the machine-readable medium 112 stores instructions that, when executed by the control circuit 110, cause the control circuit 110 to execute one or more trained machine learning models 114. In some embodiments, the one or more trained machine learning models 114 may be stored in the same machine-readable medium 112 storing instructions and/or another machine-readable medium 112.

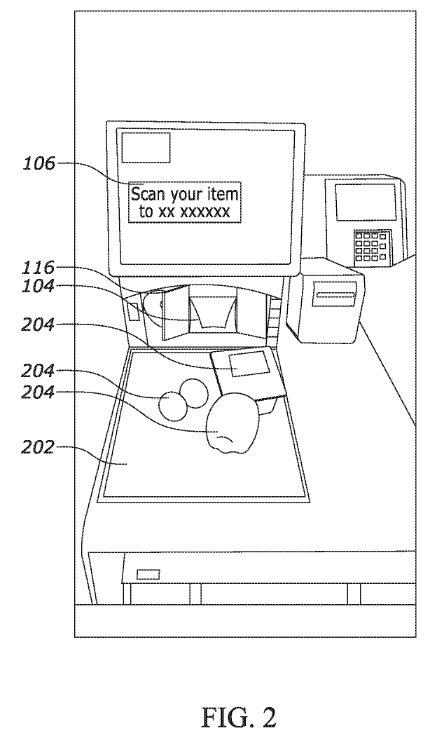

FIG. 2 illustrates an example item staging area 202 of an item identification system 100 in FIG. 1 in accordance with some embodiments. The item staging area 202 may receive one or more items 204 to be included in a transaction at a facility (e.g., a retail store, a warehouse, a commercial store, to name a few). The item staging area 202 shown in FIG. 2 is a fixed platform. Alternatively or in addition, the item staging area 202 may include checkout station, a shopping cart, a basket, an extended platform, a conveyance belt, workstation, shipment processing station, return station, pickup station, and/or an area proximate the optical scanner 104, the display 106, and/or the camera 116, and/or any fixed/designated or not fixed/undesignated area used with or without handheld device and/or any area used for any frictionless checkout, or any combination thereof described herein. In some embodiments, the item staging area is a virtual area, e.g., there is not a dedicated hardware station but is a space where item identification using cameras occurs, and is associated with a display and/or camera. For example, the item staging area may be a space through which a user passes to identify items (e.g., a user passes a doorway or passageway), or may be a space that a user passes items through or by to be seen by the camera (e.g., a user passes an item in a space near a camera, such as in to basket or tote) and there is an associated display (e.g., an associated display may be coupled to the camera or area, may be part of a mobile user display, part of mobile facility employee display, and so on). It is further noted that in some embodiments, a user passes with items, or passes items through, the item staging area. In some embodiments, a user may be a customer, an employee, a third-party vendor or contractor, for example. In some embodiments, the user can be a non-human user such as a robotic device or equipment, such as an autonomous, semi-autonomous, or controlled robot, drone or robotic component of another device, such as a robotic arm having end of arm manipulation tools, for example.

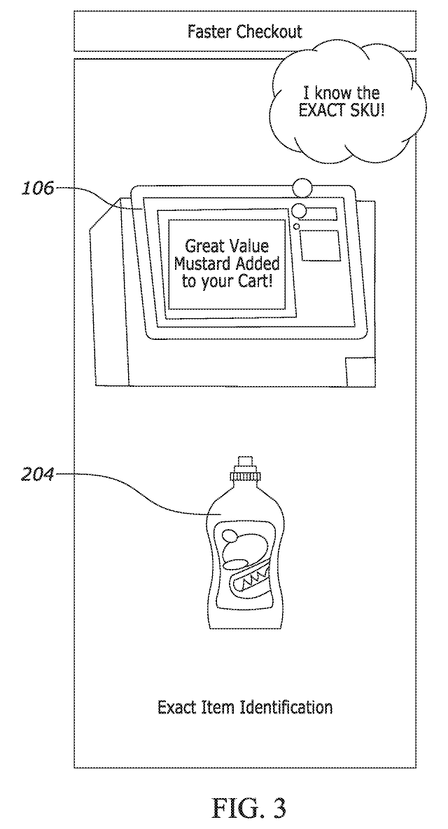

FIGS. 3-6 are illustrative diagrams depicting executions of a trained machine learning model 114 by a control circuit 110 to identify items for completion of a purchase transaction at a facility. It is understood that the trained machine learning model 114 may include one or more trained machine learning models each separately trained but when executed as a whole accomplishes the functions described herein. For example, an item staging area 202 may receive an item 204 to be included in a transaction (e.g., purchase transaction) at a facility. By one approach, the item 204 for purchase may be placed on the item staging area 202 by a purchaser (or interchangeably referred to as a user). In some embodiments, the optical scanner 104 captures a machine-readable code of the item 204. The trained machine learning model 114 when executed by the control circuit 110 identifies the items 204 based on the captured machine-readable code (e.g., a barcode, a Quick Response (QR) code, and/or any machine-readable codes capable of being read electronically by an electronic device configured to read such a machine-readable code). Alternatively or in addition, the trained machine learning model 114 when executed by the control circuit 110 identifies the item based on at least an image captured by the camera 116. The optical scanner 104 and the camera 116 are each configured/mounted at a location where each can easily/conveniently capture the machine-readable code or the image, respectively.

In some embodiments, the trained machine learning model 114, when executed by the control circuit 110, performs at least one of the rules illustrated in FIGS. 3-6 based on whether the machine-readable code is received or not, whether the item 204 is identified based on the captured image, and/or whether the machine-readable code matches the captured image (that is, the trained machine learning model 114 is able to identify/recognize that a captured machine-readable code and a captured image correspond to the same item 204). For example, if the captured machine-readable code corresponds to a toothpaste and the captured image corresponds to a tomato paste tube, the trained machine learning model 114 may determine that the captured machine-readable code and the captured image do not correspond to the same item. The trained machine learning model 114 described herein is initially trained with initial input data and has been configured to be retrained and/or re-check its accuracy with each complete transaction. As such, the trained machine learning model 114 sees each complete transaction as an opportunity for self-improvement and for accuracy check. In some embodiments, the trained machine learning model 114 may perform a confidence level and/or a threshold level determination prior to deciding which one or more of the rules described herein to execute and/or identifying the item. In an illustrative non-limiting example, the trained machine learning model 114 may determine a count of items present in the item staging area 202, e.g., the count being determined when the model identifies a number of items at a confidence level above a threshold count confidence level. Alternatively or in addition, to identify an item, the trained machine learning model 114 may determine the category of the item (e.g., energy drink category), e.g., the category of being determined when the model identifies an item type at a confidence level above a threshold type confidence level. Alternatively or in addition, the trained machine learning model 114 may determine a sub-category of the item (e.g., red bull), e.g., the sub-category of being determined when the model identifies a sub-category at a confidence level above a threshold sub-category confidence level. Alternatively or in addition, the trained machine learning model 114 may further determine a second level sub-category of the item (e.g., a diet or regular red bull), e.g., the second level sub-category of being determined when the model identifies a second level sub-category at a confidence level above a threshold second level sub-category confidence level. In some embodiments, the model may apply different confidence levels depending on what is being analyzed and determined by the model. Alternatively or in addition, in an event that the trained machine learning model 114 is not able to identify the item after performing the last category or one or more sub-category determinations, the trained machine learning model 114 may be trained to determine and execute one or more of the rules described herein. Moreover, the trained machine learning model 114 may be based on at least in part on supervised learning, unsupervised learning, semi-supervised learning, and/or reinforcement learning (e.g., linear regression, neural networks, self-supervised learning, deep learning, naïve bayes, and random forest, to name a few). It is understood that a person of ordinary skill in the art is familiar with these algorithms, and as such, will not be further explained herein.

For example, FIG. 3 illustrates an exact identification rule in accordance with some embodiments. In some embodiments, an exact identification rule is an example rule that may be applied by the model or process to enhance item determination and system performance. In some embodiments, upon a determination that the machine-readable code of an item 204 is received and upon a determination that the captured machine-readable code and the captured image do not correspond to the same item, the trained machine learning model 114 automatically updates content shown in the display 106 to identify the item 204 based on the captured image. As such, the content shown in the display 106 indicate to the purchaser that the item 204 has been presented for purchase (that is, once the purchaser indicates its intention to complete the transaction, the purchaser will be charged the cost of the item). In such an example, the trained machine learning model 114 is able to identify the item based on it recognizing that the image corresponds to a particular item identifier (e.g., the stored machine-readable code (e.g., stock keeping unit (SKU))). In some embodiments, the model identifies the item as an exact match (i.e., representing an exact identification of an item) when the confidence level of the determination meets or exceeds an identification confidence threshold.

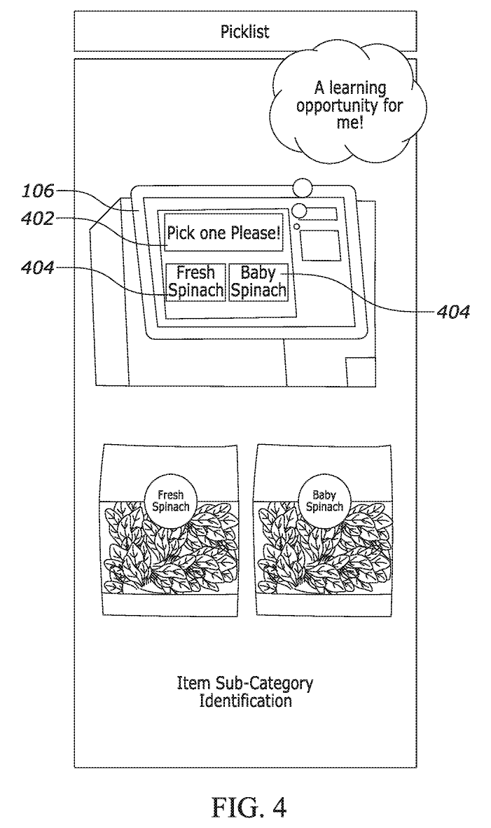

In another example, FIG. 4 illustrates a picklist rule in accordance with some embodiments. In some embodiments, a picklist rule is an example rule that may be applied by the model or process to enhance item determination and system performance. In some embodiments, upon a determination that the machine-readable code is not received and the trained machine learning model 114 is able to determine an item sub-category corresponding to the item 204 based on the image but unable to identify the item, the trained machine learning model 114 automatically updates content shown in the display 106 to provide at least two items 404 similar to or related to the item 204 with a prompt 402 for a user selection of an item from the at least two items 404 corresponding to the item 204 intended for purchase by the purchaser. In some embodiments, the at least two items are determined by the trained machine learning model 114 based on association with the stored machine-readable code of the item 204, association with the captured image, or any combination thereof. For example, in some embodiments, the vision system does not identify the item beyond a defined confidence threshold, and selects the at least two items for display to the user, e.g., each of the at least two items having a confidence level below the defined threshold but above a similarity confidence threshold.

In some embodiments, as described herein, a stored machine-readable code is a machine-readable code associated with a particular item in an inventory database (not shown). The trained machine learning model 114 may access the inventory database to determine the corresponding stored machine-readable code of the item 204. In some embodiments, as described herein, automatically updating the trained machine learning model 114 corresponds to automatically identifying the item 204 next time the machine-readable code associated with the item 204 is captured, the image of the item 204 is captured, or any combination thereof in response to the user selection of the intended item. Alternatively or in addition, the instructions, when executed, may further cause the control circuit to execute the trained machine learning model 114 to: include the item 204 among other items to be purchased by the user in response to the user selection of the intended item. Alternatively or in addition, the instructions, when executed by the control circuit 110, may cause the control circuit 110 to execute the trained machine learning model 114 further to automatically include the item 204 among other items to be purchased by the user upon a determination that the machine-readable code of the item 204 is received/captured and upon a determination that that the captured machine-readable code and the captured image correspond to the same item.

For example, as shown in FIG. 4, the trained machine learning model 114 determines that the captured image correspond to an item sub-category associated with a packaged spinach of a particular brand. However, there are a number of items that correspond to the packaged spinach of that particular brand. As such, the trained machine learning model 114 is unable to identify which one of the packaged spinach of that particular brand the item correspond to. In other words, the trained machine learning model 114 is unable to identify the corresponding stored machine-readable code associated with the item 204. In such an example, the prompt 402 enables the trained machine learning model 114 to interact with the purchaser to enlist the purchaser’s assistance in teaching the trained machine learning model 114 that the captured image correspond to the item selected by purchaser/user. Alternatively or in addition, the trained machine learning model 114 automatically updates/retrains itself in order to identify the item 204 next time it is presented for purchase. As such, the trained machine learning model 114 recognizes this as an opportunity to learn or retrain itself or self-improve itself.

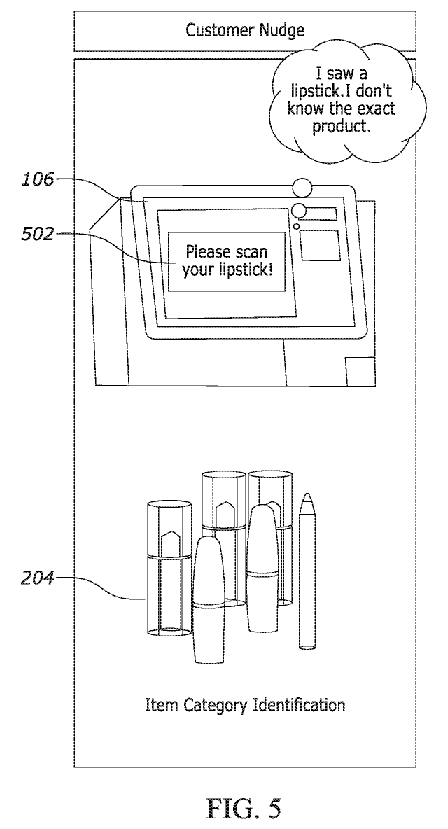

In another example, FIG. 5 illustrates a customer nudge rule in accordance with some embodiments. In some embodiments, a customer nudge rule is an example rule that may be applied by the model or process to enhance item determination and system performance. In some embodiments, upon a determination that the machine-readable code is not received and the trained machine learning model 114 is able to determine an item category corresponding to the item 204 based on the image but unable to identify the item, the trained machine learning model 114 automatically updates the content shown in the display 106 to provide a prompt 502 to scan the item 204 with the optical scanner 104. In such an example, the trained machine learning model 114 determines that the item 204 correspond to a particular item category. However, the trained machine learning model 114 is unable to identify the item (that is, the trained machine learning model 114 is unable to determine based on the captured image the corresponding stored machine-readable code). As such, via the prompt 502, the trained machine learning model 114 is enlisting the purchaser’s assistance in providing the trained machine learning model 114 the machine-readable code by requesting the purchaser to scan the machine-readable code of the item 204. The trained machine learning model 114 may then associate the captured machine-readable code with the captured image in order for it to be able to identify the item 204 next time the item is presented for purchase. In some embodiments, the model is not able to identify the item and there are no leading similar items above a similarity confidence level, such that the user is nudged to scan the items using the optical scanner or other scanner.

In some embodiments, in response to the prompt 502, the trained machine learning model 114 may wait for a period of time (for example, a number of seconds (e.g., any seconds between and including 60 seconds) and/or minutes (e.g., 1 minute, 2 minutes, 3 minutes, to name a few), and/or any combination of minutes and seconds) to receive a machine-readable code. Alternatively or in addition, the trained machine learning model 114 may determine after waiting for the period of time that a machine-readable code has not been received, the trained machine learning model 114 may perform an escalation rule. For example, the escalation rule may include the trained machine learning model 114 automatically sending and/or transmitting an instruction to an electronic device associated with an associate of the facility instructing the associate to go to the corresponding item staging area to assist the purchaser/customer/user.

In some embodiments, subsequent to the prompt 502, the trained machine learning model 114 may receive an indication from the purchaser/customer/user that all items have been presented for purchase. In such embodiments, the trained machine learning model 114, in response to the indication, may determine whether the item 204 that is associated with the determined item category and/or the reason for the prompt 502 is included in the items already presented for purchase. Alternatively or in addition, in response to the determination that the item 204 is not included in the items already presented for purchase, the trained machine learning model 114 may perform the escalation rule.

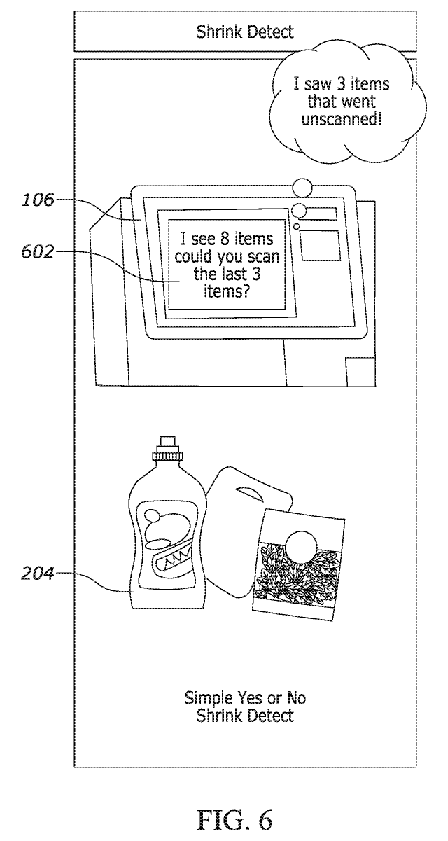

In another example, FIG. 6 illustrates a shrink detect rule in accordance with some embodiments. In some embodiments, a shrink detect rule is an example rule that may be applied by the model or process to enhance item determination and system performance. In some embodiments, upon a determination that the machine-readable code is not received and the trained machine learning model 114 is unable to identify the item but the item has been indicated by the purchaser that the item has been presented for purchase, the trained machine learning model 114 automatically updates the content shown in the display 106 to provide a prompt 602 to scan the item 204 with the optical scanner 104. In some embodiments, the trained machine learning model 114 determines that the item 204 has been presented for purchase when the purchaser places the item 204 in a bag or in a bagging area and/or indicates to tally up the purchase. In some embodiments, the trained machine learning model 114 is trained to interpret the movements/actions made by the purchaser while completing the transaction based on one or more captured images during the transaction. In some embodiments, using detected item counts and item identifications, the system can determine the number of un-identified items.

In some embodiments, when the trained machine learning model 114 determines that the prompt 602 has not been complied with by the purchaser, the trained machine learning model 114 may send a message to an electronic device associated with an associate and/or provide an indication to the associate (e.g., a flashing indicator associated with the item staging area) that the purchaser is needing assistance. In some embodiments, regardless of whether the prompt has been complied with, the model may send a message to the electronic device. In some embodiments, the model triggers an electronic message to be generated and communicated to the electronic device. In some cases, the electronic device can be a server, a computer, a module electronic system, a speaker, a visual or haptic indicator, and so on. In some embodiments, the electronic message controls another system or results in an automated action. For example, should the model conclude a shrink event has occurred, the electronic message may cause an alarm system to be activated, a digital or mechanical lock to activate, a light to flash, security to be contacted, logs to be generated, and so on.

In some embodiments, when the trained machine learning model 114 receives an indication from the purchaser/customer/user that all items have been presented for purchase, the trained machine learning model 114 may count the total number of items already presented for purchase and compare the count to a count of items in a bill or invoice due to the purchaser/customer. In some embodiments, if there is a mismatch between the count of the total number of items already presented for purchase and the count of items in the bill or invoice, the trained machine learning model 114 may perform the escalation rule.

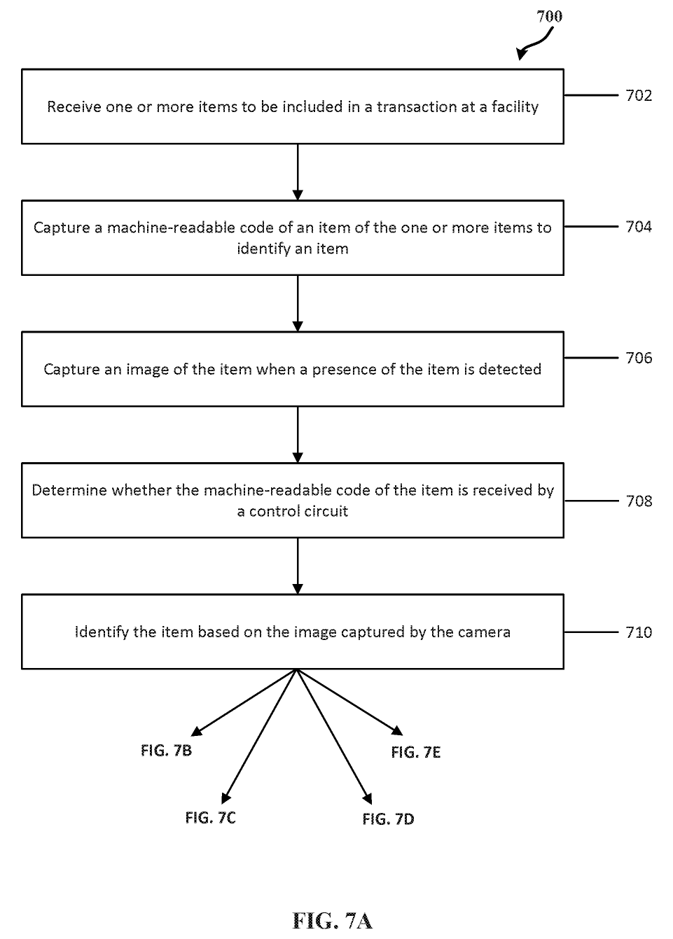

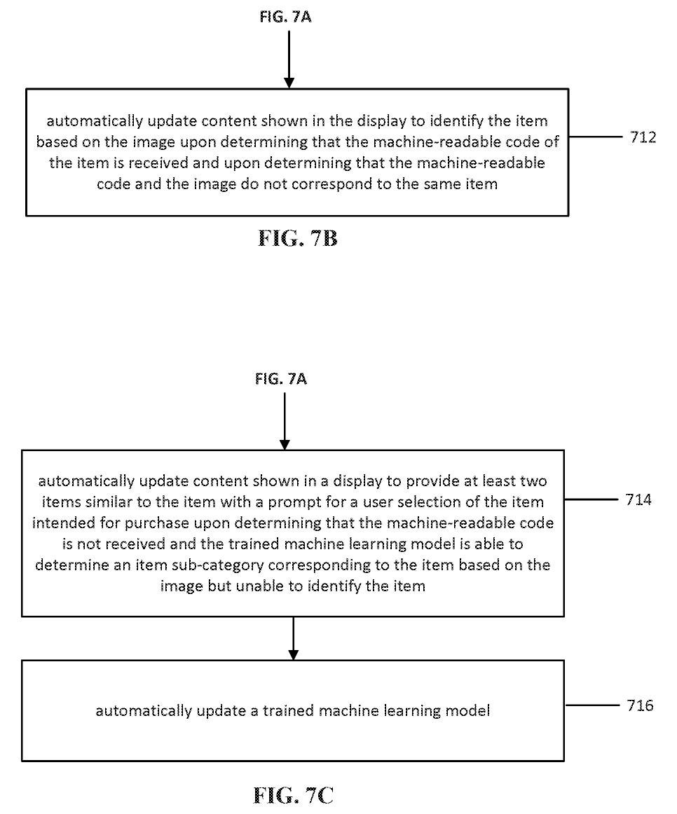

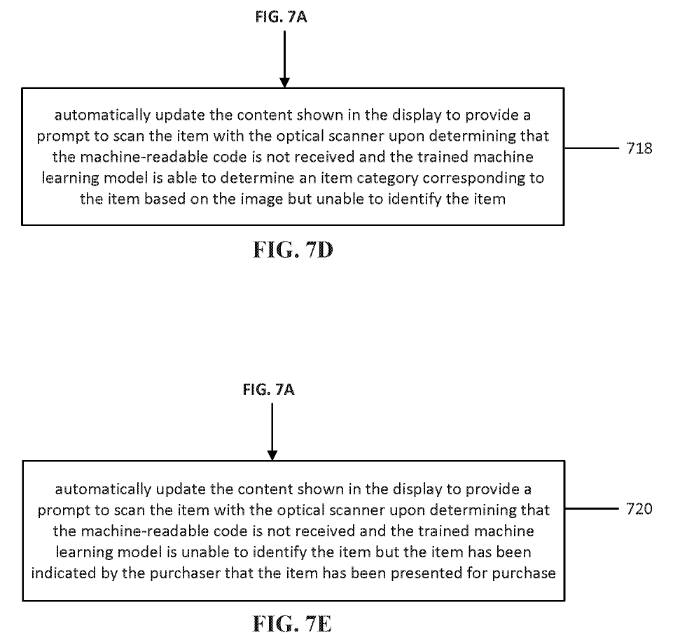

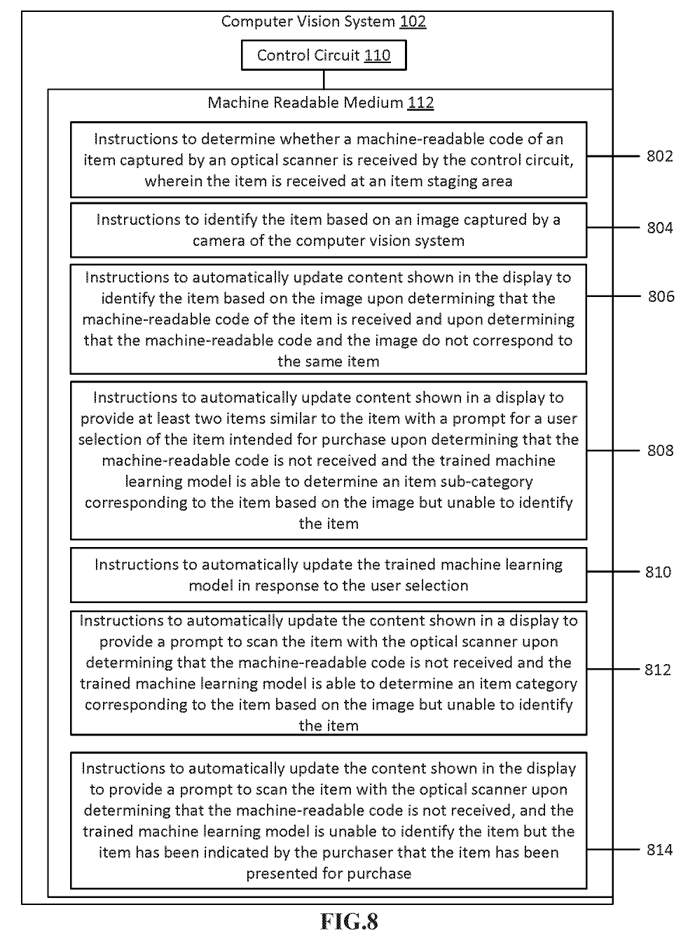

FIGS. 7A through 7E are flow diagrams depicting an example method 700 for item identification in accordance with some embodiments. In some embodiments, the steps described herein of the method 700 may be implemented and/or executed by the computer vision system 102 of FIG. 1 and/or other systems. In some embodiments, the steps described herein of the method 700 may correspond to one or more of the illustrative diagrams in FIGS. 3-6 depicting executions of the trained machine learning model 114 by the control circuit 110 to identify items for completion of a purchase transaction at a facility. The method 700 includes, at step 702 shown in FIG. 7A, receiving, at an item staging area, one or more items to be included in a transaction at a facility. Alternatively or in addition, the method may include, at step 704 shown in FIG. 7A, capturing, by an optical scanner, a machine-readable code of an item of the one or more items to identify the item. Alternatively or in addition, the method may include, at step 706 shown in FIG. 7A, capturing, by a camera of a computer vision system having a lens, an image of the item when a presence of the item is detected. Alternatively or in addition, the method may include, at step 708 shown in FIG. 7A, determining, by a trained machine learning model when executed by a control circuit of the computer vision system, whether the machine-readable code of the item is received by the control circuit. Alternatively or in addition, the method may include, at step 710 shown in FIG. 7A, identifying, by the trained machine learning model when executed by the control circuit, the item based on the image captured by the camera.

Alternatively or in addition, the method may include, at step 712 shown in FIG. 7B, automatically updating, by the trained machine learning model when executed by the control circuit, content shown in the display to identify the item based on the image upon determining that the machine-readable code of the item is received and upon a determination that the machine-readable code and the image do not correspond to the same item. Alternatively or in addition, the method may include, at step 714 shown in FIG. 7C, automatically updating, by the trained machine learning model when executed by the control circuit, content shown in the display to provide at least two items similar to the item with a prompt for a user selection of the item intended for purchase upon determining that the machine-readable code is not received and the trained machine learning model is able to determine an item sub-category corresponding to the item based on the image but unable to identify the item. Alternatively or in addition, the method may include, at step 716 of FIG. 7C, automatically updating, by the trained machine learning model when executed by the control circuit, the trained machine learning model.

Alternatively or in addition, the method may include, at step 718 shown in FIG. 7D, automatically updating, by the trained machine learning model when executed by the control circuit, the content shown in the display to provide a prompt to scan the item with the optical scanner upon determining that the machine-readable code is not received and the trained machine learning model is able to determine an item category corresponding to the item based on the image but unable to identify the item. Alternatively or in addition, the method may include, at step 720 shown in FIG. 7E, automatically updating, by the trained machine learning model when executed by the control circuit, the content shown in the display to provide a prompt to scan the item with the optical scanner upon determining that the machine-readable code is not received and the trained machine learning model is unable to identify the item but the item has been indicated by the purchaser that the item has been presented for purchase.

FIG. 8 depicts a control circuit 110 coupled to a non-transitory machine-readable medium 112 encoded with example instructions 802, 804, 806, 808, 810, 812, 814. The control circuit 110 and medium 112 may be implemented on the computer vision system 102 and/or other systems. The instructions may be an implementation of identifying an item for transaction completion.

Instructions 802, when executed, cause the control circuit 110 to determine whether a machine-readable code of an item captured by an optical scanner is received by the control circuit, wherein the item is received at an item staging area.

Instructions 804, when executed, cause the control circuit 110 to identify the item based on an image captured by a camera of the computer vision system.

Instructions 806, when executed, cause the control circuit 110 to automatically update content shown in the display to identify the item based on the image upon determining that the machine-readable code of the item is received and upon determining that the machine-readable code and the image do not correspond to the same item.

Instructions 808, when executed, cause the control circuit 110 to automatically update content shown in a display to provide at least two items similar to the item with a prompt for a user selection of the item intended for purchase upon determining that the machine-readable code is not received and the trained machine learning model is able to determine an item sub-category corresponding to the item based on the image but unable to identify the item.

Instructions 810, when executed, cause the control circuit 110 to automatically update the trained machine learning model in response to the user selection.

Instructions 812, when executed, cause the control circuit 110 to automatically update the content shown in a display to provide a prompt to scan the item with the optical scanner upon determining that the machine-readable code is not received and the trained machine learning model is able to determine an item category corresponding to the item based on the image but unable to identify the item.

Instructions 814, when executed, cause the control circuit 110 to automatically update the content shown in the display to provide a prompt to scan the item with the optical scanner upon determining that the machine-readable code is not received, and the trained machine learning model is unable to identify the item, but the item has been indicated by the purchaser that the item has been presented for purchase.

Those skilled in the art will recognize that a wide variety of other modifications, alterations, and combinations can also be made with respect to the above described embodiments without departing from the scope of the disclosure.

1. An item identification system for transaction completion comprising:
an item staging area to receive one or more items to be included in a transaction at a facility;
an optical scanner to capture a machine-readable code of an item of the one or more items to identify the item;
a display; and
a computer vision system comprising:
a camera having a lens to capture an image of the item when a presence of the item is detected;
a control circuit; and
a machine-readable medium storing instructions that, when executed by the control circuit, cause the control circuit to execute a trained machine learning model to:
determine whether the machine-readable code of the item is received by the control circuit;
identify the item based on the image captured by the camera;
upon a determination that the machine-readable code of the item is received and upon a determination that the machine-readable code and the image do not correspond to a same item, automatically update content shown in the display to identify the item based on the image;
upon a determination that the machine-readable code is not received and the trained machine learning model is able to determine an item sub-category corresponding to the item based on the image but unable to identify the item:
automatically update content shown in the display to provide at least two items similar to the item with a prompt for a user selection of the item intended for purchase; and
automatically update the trained machine learning model;
upon a determination that the machine-readable code is not received and the trained machine learning model is able to determine an item category corresponding to the item based on the image but unable to identify the item, automatically update the content shown in the display to provide a prompt to scan the item with the optical scanner; and
upon a determination that the machine-readable code is not received and the trained machine learning model is unable to identify the item but the item has been indicated by a user that the item has been presented for purchase, automatically update the content shown in the display to provide a prompt to scan the item with the optical scanner.

2. The item identification system of claim 1, wherein the item staging area comprises at least one of a checkout station, a shopping cart, and a basket.

3. The item identification system of claim 1, wherein the machine-readable code comprises at least one of a barcode and a Quick Response (QR) code, and wherein upon the determination that the machine-readable code of the item is not received, the trained machine learning model is executed to an escalation rule that includes the trained machine learning model sending an instruction to an electronic device associated with an associate of the facility instructing the associate to go to the item staging area.

4. The item identification system of claim 1, wherein the at least two items are determined based on association with the machine-readable code, association with the image, or any combination thereof.

5. The item identification system of claim 1, wherein automatically updating the trained machine learning model corresponds to automatically identifying the item next time the machine-readable code associated with the item is captured, the image of the item is captured, or any combination thereof in response to the user selection of the intended item.

6. The item identification system of claim 1, wherein the instructions, when executed, further cause the control circuit to execute the trained machine learning model to: include the item among other items to be purchased by the user in response to the user selection of the intended item.

7. The item identification system of claim 1, wherein the instructions, when executed by the control circuit, cause the control circuit to execute the trained machine learning model further to:
wherein upon a determination that the machine-readable code of the item is received and upon a determination that that the machine-readable code and the image correspond to the same item:
automatically include the item among other items to be purchased by the user.

8. A method for transaction completion, the method comprising:
receiving, at an item staging area, one or more items to be included in a transaction at a facility;
capturing, by an optical scanner, a machine-readable code of an item of the one or more items to identify the item;
capturing, by a camera of a computer vision system having a lens, an image of the item when a presence of the item is detected;
determining, by a trained machine learning model when executed by a control circuit of the computer vision system, whether the machine-readable code of the item is received by the control circuit;
identifying, by the trained machine learning model when executed by the control circuit, the item based on the image captured by the camera;
upon a determination that the machine-readable code of the item is received and upon a determination that the machine-readable code and the image do not correspond to a same item, automatically updating, by the trained machine learning model when executed by the control circuit, content shown in a display to identify the item based on the image;
upon a determination that the machine-readable code is not received and the trained machine learning model is able to determine an item sub-category corresponding to the item based on the image but unable to identify the item:
automatically updating, by the trained machine learning model when executed by the control circuit, content shown in the display to provide at least two items similar to the item with a prompt for a user selection of the item intended for purchase; and
automatically updating, by the trained machine learning model when executed by the control circuit, the trained machine learning model;
upon a determination that the machine-readable code is not received and the trained machine learning model is able to determine an item category corresponding to the item based on the image but unable to identify the item, automatically updating, by the trained machine learning model when executed by the control circuit, the content shown in the display to provide a prompt to scan the item with the optical scanner; and
upon a determination that the machine-readable code is not received and the trained machine learning model is unable to identify the item, but the item has been indicated by a user that the item has been presented for purchase, automatically updating, by the trained machine learning model when executed by the control circuit, the content shown in the display to provide a prompt to scan the item with the optical scanner.

9. The method of claim 8, wherein the item staging area comprises at least one of a checkout station, a shopping cart, and a basket.

10. The method of claim 8, wherein the machine-readable code comprises at least one of a barcode and a Quick Response (QR) code, and further comprising, upon the determination that the machine-readable code of the item is not received, executing, by the trained machine learning model, an escalation rule that includes the trained machine learning model sending an instruction to an electronic device associated with an associate of the facility instructing the associate to go to the item staging area.

11. The method of claim 8, wherein the at least two items are determined based on association with the machine-readable code, association with the image, or any combination thereof.

12. The method of claim 8, wherein automatically updating the trained machine learning model corresponds to automatically identifying the item next time the machine-readable code associated with the item is captured, the image of the item is captured, or any combination thereof in response to the user selection of the item intended for purchase.

13. The method of claim 8, further comprising including, by the trained machine learning model when executed by the control circuit, the item among other items to be purchased by the user in response to the user selection of the item intended for purchase.

14. The method of claim 8, further comprising: wherein upon a determination that the machine-readable code of the item is received and upon a determination that that the machine-readable code and the image correspond to the same item:
automatically including, by the trained machine learning model when executed by the control circuit, the item among other items to be purchased by the user.

15. A non-transitory machine-readable medium storing instructions executable by a control circuit of a computer vision system executing a trained machine learning model, the non-transitory machine-readable medium comprising:
instructions to determine whether a machine-readable code of an item captured by an optical scanner is received by the control circuit, wherein the item is received at an item staging area of a facility;
instructions to identify the item based on an image captured by a camera of the computer vision system;
instructions to automatically update content shown in a display to identify the item based on the image upon determining that the machine-readable code of the item is received and upon determining that the machine-readable code and the image do not correspond to a same item;
instructions to automatically update content shown in a display to provide at least two items similar to the item with a prompt for a user selection of the item intended for purchase upon determining that the machine-readable code is not received and the trained machine learning model is able to determine an item sub-category corresponding to the item based on the image but unable to identify the item;
instructions to automatically update the trained machine learning model in response to the user selection; and
instructions to automatically update the content shown in a display to provide a prompt to scan the item with the optical scanner upon determining that the machine-readable code is not received and the trained machine learning model is able to determine an item category corresponding to the item based on the image but unable to identify the item; and
instructions to automatically update the content shown in the display to provide a prompt to scan the item with the optical scanner upon determining that the machine-readable code is not received, and the trained machine learning model is unable to identify the item, but the item has been indicated by a user that the item has been presented for purchase.

16. The non-transitory machine-readable medium of claim 15, wherein the item staging area comprises at least one of a checkout station, a shopping cart, and a basket.

17. The non-transitory machine-readable medium of claim 15, wherein the machine-readable code comprises at least one of a barcode and a Quick Response (QR) code, and wherein the non-transitory machine-readable medium comprises instructions that, upon the determining that the machine-readable code of the item is not received, cause the trained machine learning model to execute an escalation rule that includes the trained machine learning model sending an instruction to an electronic device associated with an associate of the facility instructing the associate to go to the item staging area.

18. The non-transitory machine-readable medium of claim 15, wherein the at least two items are determined based on association with the machine-readable code, association with the image, or any combination thereof.

19. The non-transitory machine-readable medium of claim 15, wherein the instructions to automatically update the trained machine learning model comprises instructions to automatically identify the item next time the machine-readable code associated with the item is captured, the image of the item is captured, or any combination thereof in response to the user selection of the item intended for purchase.

20. The non-transitory machine-readable medium of claim 15, further comprising instructions to include the item among other items to be purchased by the user in response to the user selection of the item intended for purchase.
